(19) United States
(12) Patent Application Publication
(10) Pub. No.: US 2007/0117459 A1
(43) Pub. Date: May 24, 2007

(54) Low profile electrical connector

(75) Inventor: Chien-Chiu Chen, Taipei (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/440,445

(22) Filed: May 25, 2006

(30) Foreign Application Priority Data
Nov. 18, 2005 (TW) 094220029

(51) Int. Cl. H01R 13/648

(52) U.S. Cl. 439/607

(57) ABSTRACT

The present invention is to provide a low profile electrical connector, which comprises an insulative housing, a plurality of electrical terminals disposed in the insulative housing and a metal shell enclosed on the insulative housing. The rear surface of the terminal seat on the insulative housing has two juxtaposed horizontal locating mechanisms for locating on a PCB. The metal shell is in a rectangular shape, the two side surfaces thereof each extends horizontally outward at least two fastening members, each fastening member is bent downward a solder leg paralleled to the respective side surface. Then the connector is mounted on the PCB having an open space through the locating mechanisms and solder legs with the half part of the connector inlaid below the open space of the PCB. Therefore, the present invention can reduce the height of the connector and spare the space of the electronic device.

### BACKGROUND OF THE INVENTION

1. Field of the Invention

The present invention relates to a low profile electrical connector, particularly to an electrical connector in which parts of the connector is inlaid below the PCB to reduce the height or profile of the electronic device.

2. Description of Related Art

Universal series bus (USB) electrical connector has a function to adjust different kinds of signal input/output, it is also one of the electrical connectors universally used at present time for data transmission. In computer accessories or peripheral devices (Such as, scanner, digital camera, keyboard and the like peripheral devices.), it mostly applies a USB electrical connector as the transmission interface. As shown in FIG. 1, which shows a conventional USB electrical connector 50, the solder legs of the electrical connector 50 are extended outward from the metal shell directly, when assembled to a printed circuit board (PCB) 60, it can't reduce the using height of the connector, the large structure of the connector occupies quite a large space in the electronic device, undoubtedly the volume of the electronic device is increased, which doesn't comply with the developing tendency of light-weight and small-size in existing electronic products. Therefore, the conventional USB connector is necessary to be improved to meet the requirements.

### SUMMARY OF THE INVENTION

It is a primary object of the present invention to provide a low profile connector, in which parts of the connector is inlaid below the PCB to reduce the height or profile of the electronic device.

To achieve the above object, the present invention provides the following creative mechanism to achieve its functions. The low profile connector comprises an insulative housing, a plurality of electrical terminals and a metal shell wherein the insulative hosing has a terminal seat, on a lower and an upper surfaces of the terminal seat, each has at least a concave groove connected with the front surface for fastening the metal shell, and on the lower surface of the terminal seat having at least another concave groove behind the concave groove. The terminal seat is formed with an outward extended mating portion for connecting with a mating connector. The rear surface of the terminal seat extends outward two supporting arms along the two side surfaces of the terminal seat respectively, on the lower surface of each supporting arm having a locating pole for locating to a PCB. The electrical terminals are disposed within the insulative housing, each having a fixing portion, a solder portion, a contact portion and a restricting portion. The metal shell consists of a first surface, a second surface and two side surfaces. The front portion of the first surface and the second surface each has at least an abutting portion which could clasp with the concave groove of the insulative housing. Each side surface extends outward at least two fastening members having a level portion and a solder leg so as to mount the connector on a PCB having an open space. The locating poles and solder legs of the connector are matched with the corresponding locating holes and insertion holes on the PCB, with the half part of the connector inlaid below the open space of the PCB. Therefore, the electrical connector of the present invention can reduce the height or profile of the connector and spare the space of the electronic device.

The above and other objects, features and advantages of the present invention will become apparent from the following detailed description taken with the accompanying drawings.

### BRIEF DESCRIPTION OF THE DRAWINGS

FIG. 1 is a perspective view of a conventional connector;

FIG. 2 is an exploded perspective view of a preferred embodiment of the present invention;

FIG. 3 is a perspective view of the insulative housing of the present invention from another angle;

FIG. 4 is a perspective view of the metal shell of the present invention from another angle;

FIG. 5 is a perspective view showing the electrical connector of the present invention to be mounted on a PCB; and

FIG. 6 is a perspective view showing the electrical connector of the present invention to be mounted on the PCB.

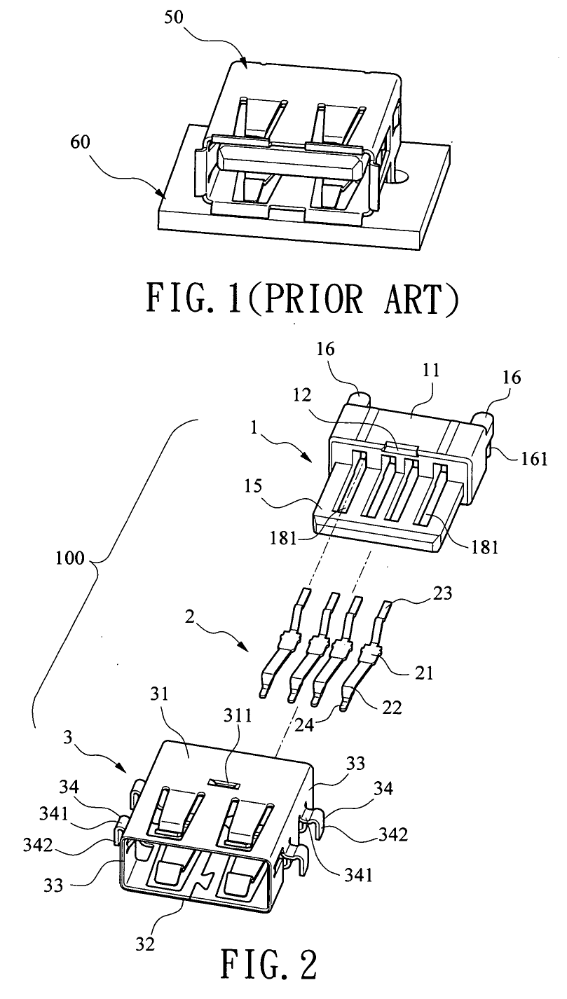

### DETAILED DESCRIPTION OF THE PREFERRED EMBODIMENTS

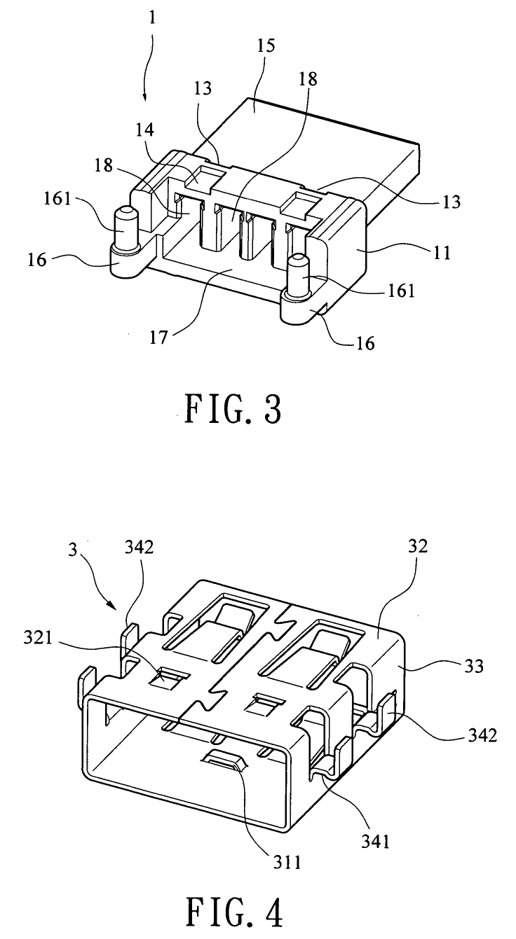

Refer to FIG. 2, which shows a preferred embodiment of a low profile electrical connector 100 of the present invention. The low profile electrical connector 100 comprises an insulative housing 1, a plurality of electrical terminals 2 and a metal shell 3 enclosed on the outside of the insulative housing 1. Now, please also refer to the structure as shown in FIGS. 3 and 4 together, a greater detail of the low profile electrical connector 100 will be illustrated as follows.

The insulative hosing 1 has a terminal seat 11. On the lower and upper surfaces of the terminal seat 11, there each has at least a concave groove 12, 13 connected with the front surface for fastening the metal shell 3, and on the lower surface of the terminal seat 11 having at least another concave groove 14 behind the concave groove 13. The terminal seat 11 is formed with an outward extended mating portion 15 for connected with a mating connector (not shown). The rear surface of the terminal seat 11 extends outward two supporting arms 16 along the two side surfaces of the terminal seat 11 respectively, on the lower surface of each supporting arm 16 having a locating pole 161 for locating to a PCB. The rear side of the terminal seat 11 has a concave chamber 17, and in the concave chamber 17, it has a plurality of through holes 18 which extend to the mating portion 15 and further extend into the low grooves 181 for disposing the electrical terminals 2.

The electrical terminals 2 are inserted to the low grooves 181 from the through holes 18 the rear side of the insulative housing 1. Each electrical terminal 2 has a fixing portion 21, a solder portion 23 extending from an end of the fixing portion 21, and a contact portion 22 extending from the other end the fixing portion 21, and a restricting portion 24 further extending therefrom.

The metal shell 3 is stamped unitarily from a metal plate, the metal shell 3 is a rectangular structure consisted of a first surface 31, a second surface 32 and two side surfaces 31 connected therebetween. On the rear portions of the first surface 31 and the second surface 32 each has at least an abutting portion 311, 321 which could clasp with the concave grooves 12, 13 and 14 of the insulative housing 1 to achieve stable engagement. The side surfaces 33 connected between the first and second surfaces each extends outward at least two fastening members 34, each fasting member 34 has a level portion 341 and a solder leg 342 extend downward from the level portion 341 paralleled to the corresponding side surface thereof, the level portions 341 are rested on the PCB to secure the entire connector on the PCB.

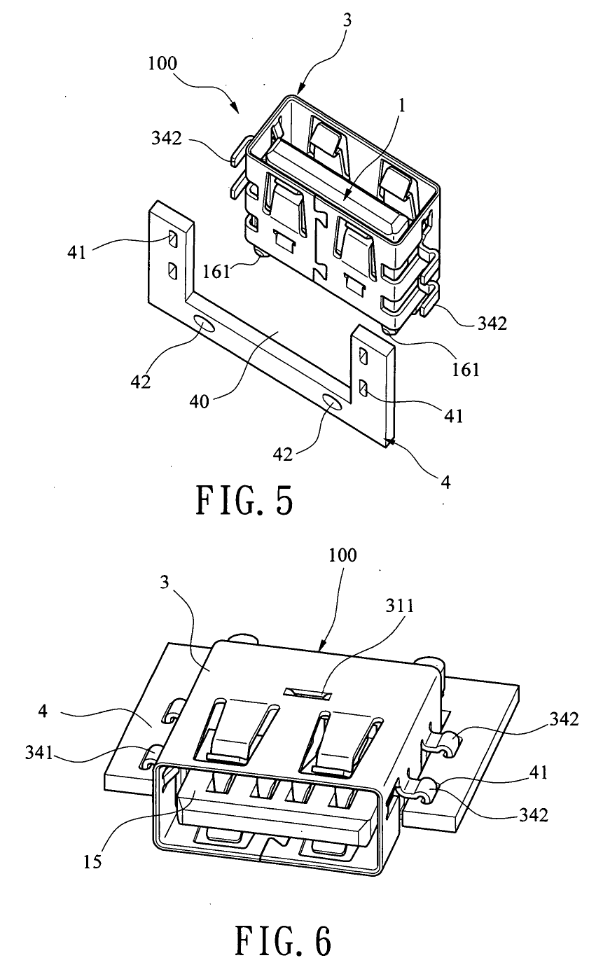

Referring to FIG. 5, it shows the assembly of the low profile electrical connector 100 of the present invention and the PCB 4. Firstly, the electrical terminals 2 are disposed within the low grooves 181 from the through holes 18 on the rear side of the insulative housing 1 to achieve stability through the engagement between the terminal fixing portions 21 and the insulative housing 1; then the half-finished product is enclosed within the metal shell 3; after that, the finished electrical connector 100 is located on the PCB 4 having an open space 40, to achieve the connector stability by matching the locating poles 161 on the rear side of the insulative housing 1 and the solder legs 342 of the metal shell 3 with the corresponding locating holes 42 and insertion holes 41 on the PCB 4, with the half part portion of the connector 100 can be inlaid below the open space 40 of the PCB 4. Thus, comparing to the conventional connectors, the electrical connector 100 of the present invention can reduce the height or profile of the product and spare the space of the electronic device, therefore, it can reduce the volume of the electronic device.

While the invention herein disclosed has been described by means of specific embodiments, numerous modifications and variations could be made thereto by those skilled in the art without departing from the scope and spirit of the invention set forth in the claims.

What is claimed is:

1. A low profile electrical connector, disposed on a PCB with an open chamber, comprising an insulative housing, a plurality of electrical terminals and a metal shell enclosed on an outside of said insulative housing, wherein a rear surface of a terminal seat on said insulative housing has two juxtaposed horizontal supporting arms, on a lower surface of each said supporting arm extending outward a locating pole; said metal shell is in a rectangular shape, two side surfaces thereof each extending horizontally outward at least two fastening members, each fastening member being bent downward and formed with a solder leg paralleled to the respective side surface.

2. The low profile connector of claim 1, wherein a plurality of through holes disposed on a rear surface of the terminal seat of said insulative housing extend to a mating portion on a front surface of the terminal seat and form a plurality of low grooves for accommodating said electrical terminals thereinto, on an upper and a lower surfaces of the terminal seat each having at least a concave groove connected with the front surface of the terminal seat.

3. The low profile connector of claim 1, wherein a first and second surfaces connected with the two side surfaces of said metal shell each has at least an abutting portion which engages with a corresponding concave groove on said insulative housing.
